(19) United States
(12) Patent Application Publication
(10) Pub. No.: US 2025/0015473 A1
(43) Pub. Date: Jan. 9, 2025

(54) TRANSITION CIRCUIT AND COMMUNICATION DEVICE

(71) Applicant: KABUSHIKI KAISHA TOSHIBA, Tokyo (JP)

(72) Inventors: Ren SHIBATA, Yokohama Kanagawa (JP); Tamio KAWAGUCHI, Kawasaki Kanagawa (JP)

(73) Assignee: KABUSHIKI KAISHA TOSHIBA, Tokyo (JP)

(21) Appl. No.: 18/423,565

(22) Filed: Jan. 26, 2024

(30) Foreign Application Priority Data
Jul. 4, 2023 (JP) 2023-110157

(51) Int. Cl. H01P 3/08; H01P 5/00

(52) U.S. Cl. CPC H01P 3/08; H01P 5/00

(57) ABSTRACT

According to one embodiment, a transition circuit includes a waveguide, first and second conductive portions, and a transmission line. The waveguide includes first and second conductive layers, and first and second side portions. A direction from the first conductive layer to the second conductive layer is along a first direction. A second direction from the first side portion to the second side portion crosses the first direction. The first conductive portion includes a first extending portion extending along the first direction. The second conductive portion includes a second extending portion extending along the first direction. The transmission line includes a signal line that includes a first line portion, a first connecting portion and a second connecting portion. The first connecting portion includes a first end portion and a first other end portion. The second connecting portion includes a second end portion and a second other end portion.

### CROSS-REFERENCE TO RELATED APPLICATIONS

This application is based upon and claims the benefit of priority from Japanese Patent Application No. 2023-110157, filed on Jul. 4, 2023; the entire contents of which are incorporated herein by reference.

### FIELD

Embodiments described herein relate generally to a transition circuit and a communication device.

### BACKGROUND

For example, transition circuits are used in various communication devices. It is desired to improve the characteristics of transition circuits.

### BRIEF DESCRIPTION OF THE DRAWINGS

FIG. 1 is a schematic perspective view illustrating a transition circuit according to a first embodiment;

FIG. 2 is a schematic plan view illustrating the transition circuit according to the first embodiment;

FIGS. 3A to 3E are schematic cross-sectional views illustrating the transition circuit according to the first embodiment;

FIG. 4A to FIG. 4C are schematic cross-sectional views illustrating the transition circuit according to the first embodiment;

FIG. 5 is a graph illustrating the characteristics of the transition circuit according to the first embodiment;

FIG. 6 is a schematic plan view illustrating the transition circuit according to the first embodiment;

FIG. 7 is a schematic plan view illustrating a transition circuit according to the first embodiment;

FIGS. 8A to 8E are schematic cross-sectional views illustrating the transition circuit according to the first embodiment;

FIGS. 9A to 9C are schematic cross-sectional views illustrating the transition circuit according to the first embodiment;

FIG. 10 is a schematic plan view illustrating a transition circuit according to the first embodiment;

FIG. 11 is a schematic perspective view illustrating a transition circuit according to the first embodiment;

FIG. 12 is a schematic cross-sectional view illustrating the transition circuit according to the first embodiment;

FIG. 13 is a graph illustrating the characteristics of the transition circuit according to the first embodiment;

FIG. 14 is a schematic perspective view illustrating a transition circuit according to the first embodiment;

FIG. 15 is a schematic perspective view illustrating a transition circuit according to the first embodiment;

FIG. 16 is a schematic perspective view illustrating a transition circuit according to the first embodiment;

FIG. 17 is a schematic perspective view illustrating a transition circuit according to the first embodiment;

FIG. 18 is a schematic perspective view illustrating a transition circuit according to the first embodiment;

FIG. 19 is a schematic cross-sectional view illustrating a transition circuit according to the first embodiment; and

FIG. 20 is a schematic diagram illustrating a communication device according to a second embodiment.

### DETAILED DESCRIPTION

According to one embodiment, a transition circuit includes) a waveguide, a first conductive portion, a second conductive portion, and a transmission line. The waveguide includes a first conductive layer, a second conductive layer, a first side portion, and a second side portion. A direction from the first conductive layer to the second conductive layer is along a first direction. The first side portion electrically connects the first conductive layer to the second conductive layer. The second side portion electrically connects the first conductive layer to the second conductive layer. A second direction from the first side portion to the second side portion crosses the first direction. The first conductive portion is provided between the first side portion and the second side portion in the second direction. The first conductive portion includes a first extending portion extending along the first direction. The first extending portion is separated from the second conductive layer. The second conductive portion is provided between the first conductive portion and the second side portion in the second direction. The second conductive portion includes a second extending portion extending along the first direction. The second extending portion is separated from the second conductive layer. The transmission line includes a signal line. The signal line includes a first line portion, a first connecting portion, and a second connecting portion. The first connecting portion includes a first end portion and a first other end portion. The second connecting portion includes a second end portion and a second other end portion. The first other end portion and the second other end portion are connected to the first line portion. The first end portion is connected to the first conductive portion. The second end portion is connected to the second conductive portion. A part of the second conductive layer is provided between the first conductive layer and at least a part of the signal line.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

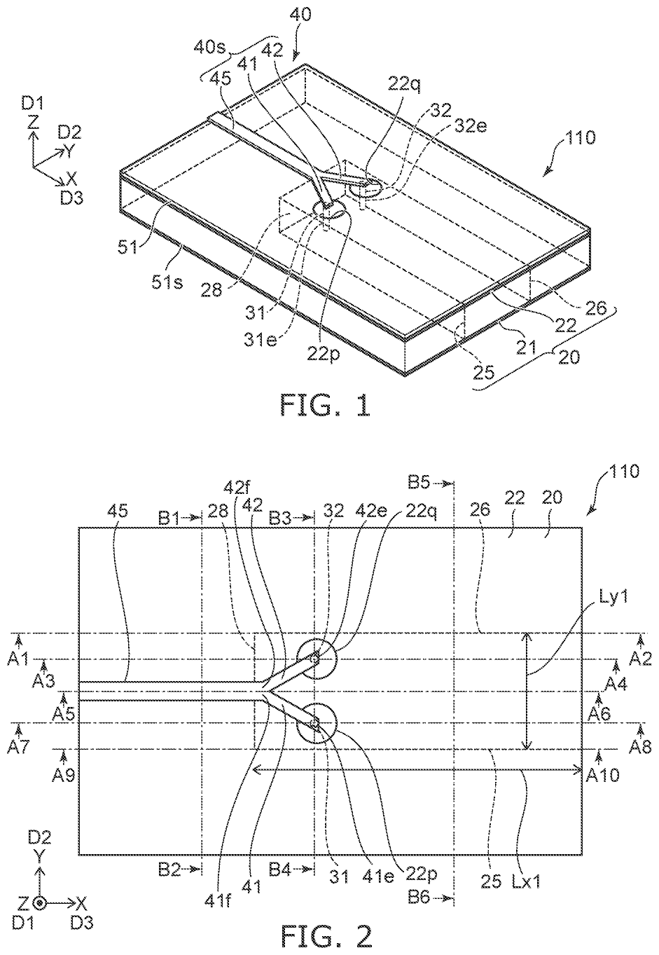

FIG. 1 is a schematic perspective view illustrating a transition circuit according to a first embodiment.

FIG. 2 is a schematic plan view illustrating the transition circuit according to the first embodiment.

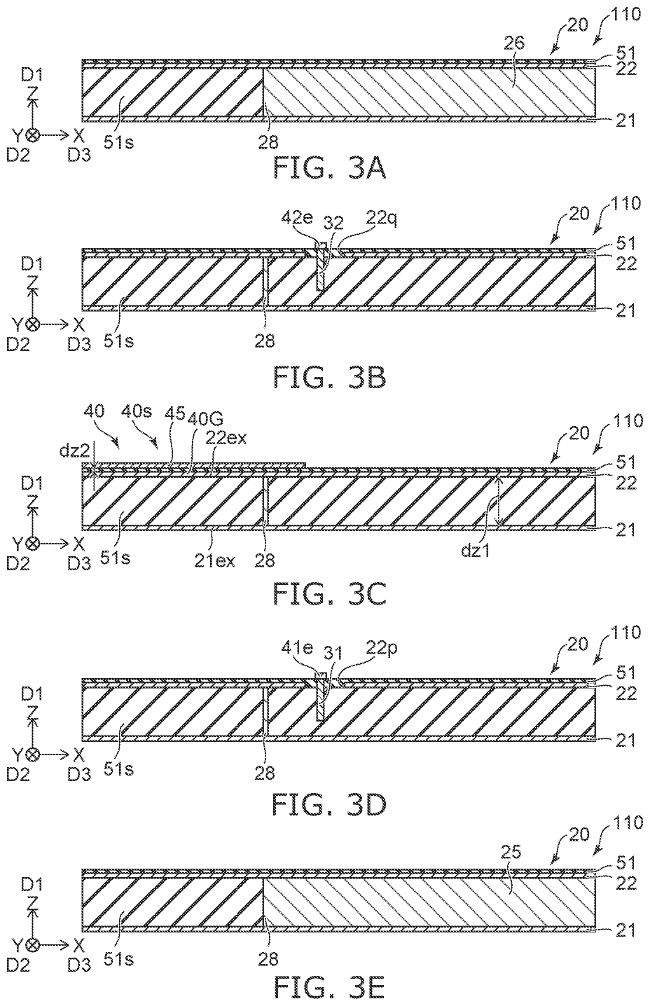

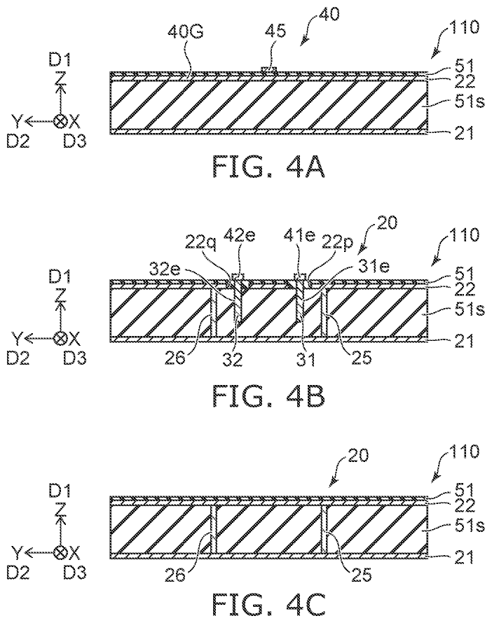

FIGS. 3A to 3E and FIG. 4A to FIG. 4C are schematic cross-sectional views illustrating the transition circuit according to the first embodiment.

FIG. 3A is a cross-sectional view taken along the line A1-A2 in FIG. 2. FIG. 3B is a cross-sectional view taken along the line A3-A4 in FIG. 2. FIG. 3C is a cross-sectional view taken along the line A5-A6 in FIG. 2. FIG. 3D is a cross-sectional view taken along the line A7-A8 in FIG. 2. FIG. 3E is a cross-sectional view taken along the line A9-A10 in FIG. 2. FIG. 4A is a cross-sectional view taken along the line B1-B2 in FIG. 2. FIG. 4B is a cross-sectional view taken along the line B3-B4 in FIG. 2. FIG. 4C is a cross-sectional view taken along the line B5-B6 in FIG. 2.

As shown in FIG. 1, a transition circuit 110 according to the embodiment includes a waveguide 20, a first conductive portion 31, a second conductive portion 32, and a transmission line 40.

The waveguide 20 includes a first conductive layer 21, a second conductive layer 22, a first side portion 25, and a second side portion 26. A direction from the first conductive layer 21 to the second conductive layer 22 is along a first direction D1.

The first direction D1 is defined as a Z-axis direction. One direction perpendicular to the Z-axis direction is defined as a Y-axis direction. A direction perpendicular to the Z-axis direction and the Y-axis direction is defined as an X-axis direction.

The first side portion 25 electrically connects the first conductive layer 21 to the second conductive layer 22. The second side portion 26 electrically connects the first conductive layer 21 to the second conductive layer 22. A second direction D2 from the first side portion 25 to the second side portion 26 crosses the first direction D1. The second direction D2 may be, for example, the Y-axis direction.

For example, the first side portion 25 and the second side portion 26 extend along the X-axis direction. As described below, the first side portion 25 and the second side portion 26 may include a plurality of conductive pillars. The plurality of conductive pillars may be, for example, a plurality of conductive pins. The plurality of conductive pillars may be, for example, a plurality of conductive pipes. The conductive pipes are hollow. The conductive pins or conductive pipes may be formed, for example, by plating a through hole. The plurality of conductive pins or the plurality of conductive pipes include, for example, metal. For example, the plurality of conductive pillars included in the first side portion 25 are arranged along the X-axis direction. The plurality of conductive pillars included in the second side portion 26 are arranged along the X-axis direction.

The first conductive portion 31 is provided between the first side portion 25 and the second side portion 26 in the second direction D2. The first conductive portion 31 includes a first extending portion 31e. The first extending portion 31e extends along the first direction D1. The first extending portion 31e is separated from the second conductive layer 22. In this example, a first opening 22p is provided in the second conductive layer 22. The first extending portion 31e passes through the first opening 22p along the Z-axis direction. With such a configuration, the first extending portion 31e may be separated from the second conductive layer 22.

The second conductive portion 32 is provided between the first conductive portion 31 and the second side portion 26 in the second direction D2. The second conductive portion 32 includes a second extending portion 32e. The second extending portion 32e extends along the first direction D1. The second extending portion 32e is separated from the second conductive layer 22. In this example, a second opening 22q is provided in the second conductive layer 22. The second extending portion 32e passes 35 through the second opening 22q along the Z-axis direction. With such a configuration, the second extending portion 32e may be separated from the second conductive layer 22.

The transmission line 40 includes a signal line 40s. The signal line 40s includes a first line portion 45, a first connecting portion 41, and a second connecting portion 42.

As shown in FIG. 2, the first connecting portion 41 includes a first end portion 41e and a first other end portion 41f. The second connecting portion 42 includes a second end portion 42e and a second other end portion 42f. The first other end portion 41f and the second other end portion 42f are connected to the first line portion 45. The first end portion 41e is connected to the first conductive portion 31. The second end portion 42e is connected to the second conductive portion 32. The first connecting portion 41 is electrically connected to the second connecting portion 42. The same (single) signal is applied to the first connecting portion 41 and the second connecting portion 42.

As shown in FIG. 4A, a part of the second conductive layer 22 is provided between the first conductive layer 21 and the first line portion 45 included in the signal line 40s. Thus, a part of the second conductive layer 22 is provided between the first conductive layer 21 and at least a part of the signal line 40s.

As shown in FIGS. 3A to 3e, the transition circuit 110 may include a base 51s and a first insulating layer 51. The base 51s is insulating. The base 51s may be, for example, a dielectric substrate. At least a part of the base 51s is provided between the first conductive layer 21 and the second conductive layer 22.

At least a part of the first insulating layer 51 is provided between a part of the second conductive layer 22 and at least a part of the signal line 40s (for example, the first line portion 45). The signal line 40s is electrically insulated from the second conductive layer 22.

For example, the second conductive layer 22 may include a portion 22ex extending to a region where the signal line 40s (for example, the first line portion 45) is provided (see FIG. 3C). For example, the second conductive layer 22 including the portion 22ex may be set to, for example, a reference potential (e.g., ground potential). In one example, the transmission line 40 may be formed by the portion 22ex and the signal line 40s.

As shown in FIG. 3C, the transmission line 40 may include a counter conductive layer 40G. In one example, the counter conductive layer 40G may be the portion 22ex of the second conductive layer 22.

As shown in FIG. 3C, a direction from the counter conductive layer 40G to the signal line 40s is along the first direction D1. A distance along the first direction D1 between the first conductive layer 21 and the second conductive layer 22 is defined as a first distance dz1. A distance along the first direction D1 between the counter conductive layer 40G and the signal line 40s (for example, the first line portion 45) is defined as a second distance dz2. The first distance dz1 is longer than the second distance dz2. The counter conductive layer 40G may be continuous with the second conductive layer 22. The counter conductive layer 40G may be provided separately from the second conductive layer 22.

Since the first distance dz1 is long, it becomes easier to reduce loss in the waveguide 20, for example. By the second distance dz2 being long, it becomes easier to reduce conductor loss, for example, in the transmission line 40, for example.

The first conductive layer 21 may extend to a region where the signal line 40s is provided. For example, the first conductive layer 21 may include a portion 21ex extending to a region where the signal line 40s (for example, the first line portion 45) is provided (see FIG. 3C). For example, the first conductive layer 21 including the portion 21ex may be set to, for example, a reference potential (e.g., ground potential). In one example, the transmission line 40 may be formed by the portion 21ex and the signal line 40s.

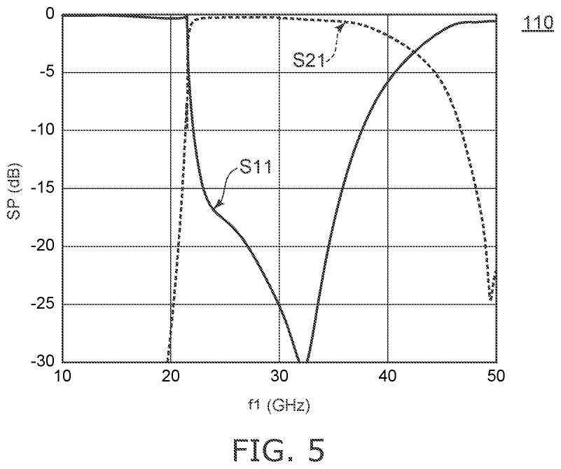

FIG. 5 is a graph illustrating the characteristics of the transition circuit according to the first embodiment.

FIG. 5 illustrates the characteristics of the transition circuit 110. The horizontal axis in FIG. 5 is the frequency f1. The vertical axis is the frequency characteristic SP of the amplitude of the S-parameter. FIG. 5 exemplifies the amplitude S11 of the reflection coefficient and the amplitude S21 of the transmission coefficient. In this example, the effects of material loss are ignored. As shown in FIG. 5, in the frequency f1 range of 23 GHz to 36 GHz, the amplitude S11 of the reflection coefficient is less than −15 dB. In the frequency f1 range of 23 GHz to 36 GHZ, the amplitude S21 of the transmission coefficient exceeds −0.3 dB. Radiation loss is suppressed. Low reflection transition is possible.

In the embodiment, the first conductive portion 31 and the second conductive portion 32 are provided. The orientations in the second direction of the electric fields of the signals radiated from each of these two conductive portions (conductive pillars) are opposite to each other. It is thought that this causes some of the electric fields leaking out of the transition circuit to cancel each other out. This is thought to reduce radiation loss. According to the embodiment, it is possible to provide a transition circuit whose characteristics can be improved.

In the embodiments, for example, the transmission line 40 transmits a single-ended signal. For example, a transition circuit that can convert the mode of a signal is provided.

In the embodiment, at least one of the first conductive layer 21 or the second conductive layer 22 includes, for example, at least one selected from the group consisting of copper, silver, aluminum, and gold. At least one of the first conductive portion 31 or the second conductive portion 32 includes, for example, at least one selected from the group consisting of copper, silver, aluminum, and gold. The signal line 40s includes, for example, at least one selected from the group consisting of copper, silver, aluminum, and gold. The base 51s may include, for example, at least one selected from the group consisting of glass cloth, resin (such as PTFE), and alumina.

As shown in FIGS. 1 and 2, the waveguide 20 may further include a third side portion 28. The third side portion 28 electrically connects the first conductive layer 21 to the second conductive layer 22. The third side portion 28 extends, for example, along the second direction D2. As shown in FIG. 3C, the third side portion 28 overlaps the transmission line 40 in the first direction D1. The third side portion 28 overlaps the first line portion 45 of the signal line 40s in the first direction D1.

The first side portion 25 and the second side portion 26 extend along a third direction D3. For example, the third direction D3 crosses a plane including the first direction D1 and the second direction D2. The third direction D3 is, for example, the X-axis direction.

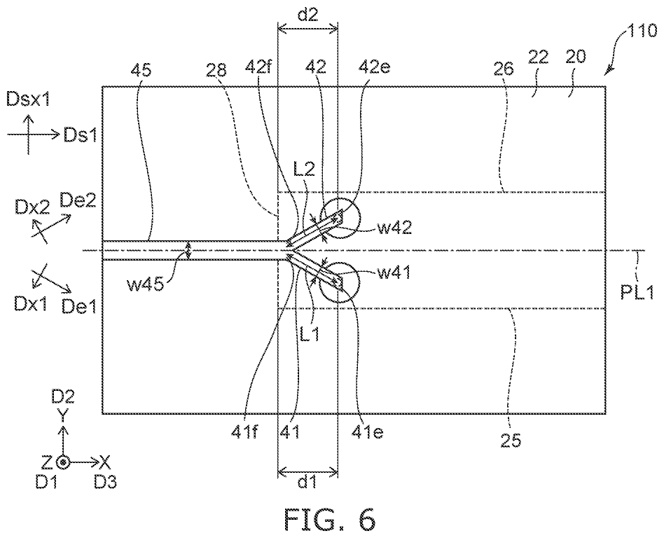

FIG. 6 is a schematic plan view illustrating the transition circuit according to the first embodiment.

As shown in FIG. 6, in the first connecting portion 41, a length (distance) between the first other end portion 41f and the first end portion 41e is defined as a first length L1. The wavelength of a signal guided through the waveguide 20 is defined as a waveguide wavelength λg. In the embodiment, it is preferable that the first length L1 is substantially (1+2n)/4 times the waveguide wavelength λg. “n” is an integer greater than or equal to 0. For example, the first length L1 is preferably not less than 0.8 times and not more than 1.2 times the value of (1+2n)/4 times the waveguide wavelength λg. Thereby, loss in the first connecting portion 41 is suppressed. “n” may be, for example, 10 or less. The first length L1 may be not less than 0.9 times and not more than 1.1 times the value of (1+2n)/4 times the waveguide wavelength λg. “n” may be, for example, 5 or less.

As shown in FIG. 6, in the second connecting portion 42, a length (distance) between the second other end portion 42f and the second end portion 42e is defined as a second length L2. In the embodiment, it is preferable that the second length L2 is substantially (1+2m)/4 times the waveguide wavelength λg. “m” is an integer greater than or equal to 0. For example, the second length L2 is preferably not less than 0.8 times and not more than 1.2 times the value of (1+2m)/4 times the guiding wavelength λg. Thereby, loss in the second connecting portion 42 is suppressed. “m” may be, for example, 10 or less. The second length L2 may be not less than 0.9 times and not more than 1.1 times the value of (1+2m)/4 times the waveguide wavelength λg. “m” may be, for example, 5 or less.

As shown in FIG. 6, a distance between the third side portion 28 and the first conductive portion 31 along the third direction D3 is defined as a first conductive portion distance d1. As already explained, the third direction D3 crosses the plane including the first direction D1 and the second direction D2. The first conductive portion distance d1 is preferably not less than 0.8 times and not more than 1.2 times the value of (1+2l)/4 times the waveguide wavelength λg of the waveguide 20. “l” is an integer greater than or equal to 0. Thereby, loss generated in the first conductive portion 31 can be suppressed. “l” may be, for example, 10 or less. The first conductive portion distance d1 may be not less than 0.9 times and not more than 1.1 times the value of (1+2l)/4 times the waveguide wavelength λg of the waveguide 20. “l” may be, for example, 5 or less.

As shown in FIG. 6, a distance between the third side portion 28 and the second conductive portion 32 along the third direction D3 is defined as the second conductive portion distance d2. The second conductive portion distance d2 is preferably not less than 0.8 times and not more than 1.2 times the value of (1+2k)/4 times the waveguide wavelength λg of the waveguide 20. “k” is an integer greater than or equal to 0. Thereby, loss generated in the second conductive portion 32 can be suppressed. “k” may be, for example, 10 or less. The second conductive portion distance d2 may be not less than 0.9 times and not more than 1.1 times the value of (1+2k)/4 times the waveguide wavelength λg of the waveguide 20. “k” may be, for example, 5 or less.

As shown in FIG. 6, the first line portion 45 extends along a signal line extending direction Ds1. In this example, the signal line extending direction Ds1 is along the third direction D3. A length (width) of the first line portion 45 along the signal line crossing direction Dsx1 is defined as a signal line width w45. The signal line crossing direction Dsx1 crosses the signal line extending direction Ds1. The signal line crossing direction Dsx1 is perpendicular to the signal line extending direction Ds1 and perpendicular to the first direction D1.

The first connecting portion 41 extends along a first extending direction De1. A length (width) of the first connecting portion 41 along a first crossing direction Dx1 is defined as a first connecting portion width w41. The first crossing direction Dx1 is perpendicular to the first extending direction De1 and the first direction D1. In the embodiment, the first connecting portion width w41 is narrower than the signal line width w45.

The second connecting portion 42 extends along a second extending direction De2. A length (width) of the second connecting portion 42 along a second crossing direction Dx2 is defined as a second connecting portion width w42. The second crossing direction Dx2 is perpendicular to the second extending direction De2 and the first direction D1. In the embodiment, the second connecting portion width w42 is narrower than the signal line width w45.

As described above, the first connecting portion 41 extends along the first extending direction De1. The second connecting portion 42 extends along the second extending direction De2. The first line portion 45 extends along the signal line extending direction Ds1. In this example, the signal line extending direction Ds1 is inclined with respect to the first extending direction De1. The signal line extending direction Ds1 is inclined with respect to the second extending direction De2.

As shown in FIG. 6, in this example, the first connecting portion 41 is plane symmetrical with respect to the second connecting portion 42. It is preferable that the first connecting portion 41 is symmetrical with respect to the second connecting portion 42 with respect to a first plane PL1. The first plane PL1 is along the first direction D1 and is perpendicular to the second direction D2. The first plane PL1 passes through the midpoint between the first side portion 25 and the second side portion 26 in the second direction D2. With such a configuration, loss can be further suppressed.

In the transition circuit 110, the transmission line 40 may include at least one of a microstrip line, a strip line, or a coplanar waveguide.

In one example regarding the transition circuit 110, the first distance dz1 is, for example, not less than 100 μm and not more than 1000 μm. The second distance dz2 is, for example, not less than 1000 μm and not more than 4000 μm. The length Lx1 (see FIG. 2) of the first side portion 25 (and the second side portion 26) along the X-axis direction is, for example, not less than 3 mm and not more than 20 mm. The distance Ly1 along the Y-axis direction between the first side portion 25 and the second side portion 26 is, for example, not less than 2 mm and not more than 10 mm. The signal line width w45 is, for example, not less than 300 μm and not more than 1000 μm. The first connecting portion width w41 is, for example, not less than 300 μm and not more than 1000 μm. The second connecting portion width w42 is, for example, not less than 300 μm and not more than 1000 μm. The waveguide wavelength λg is, for example, not less than 5 mm and not more than 20 mm. The first length L1 may be, for example, approximately 2.5 mm or approximately 7.5 mm. The second length L2 may be, for example, approximately 2.5 mm or approximately 7.5 mm.

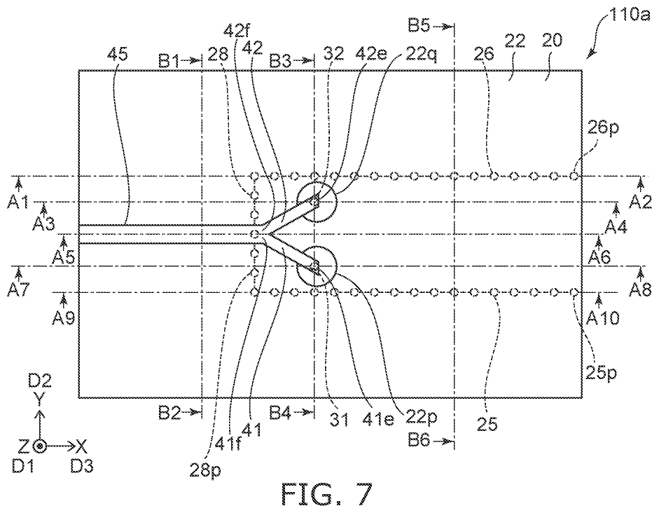

FIG. 7 is a schematic plan view illustrating a transition circuit according to the first embodiment.

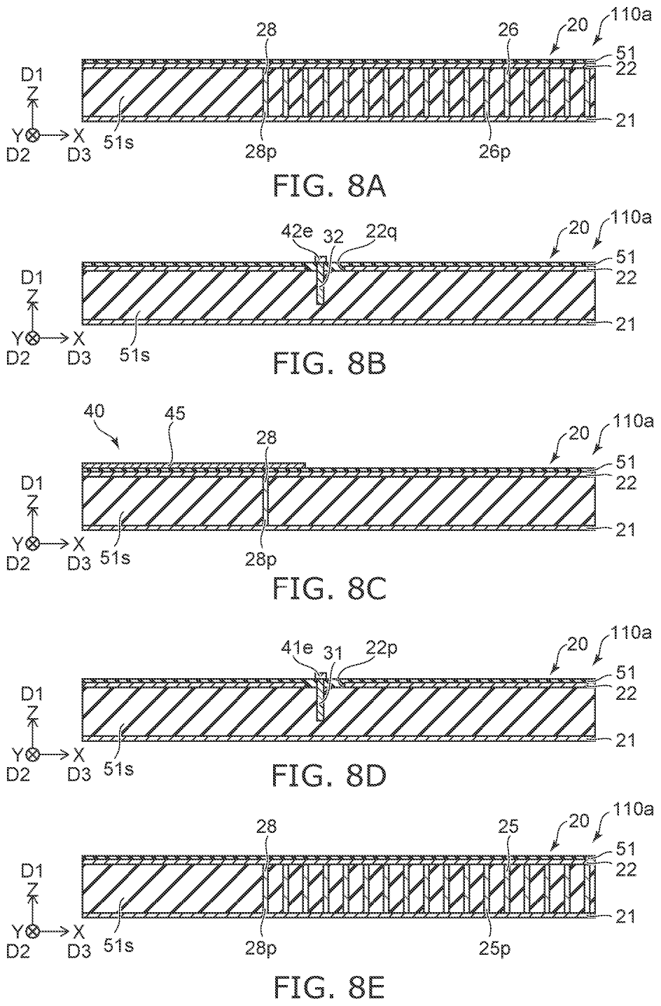

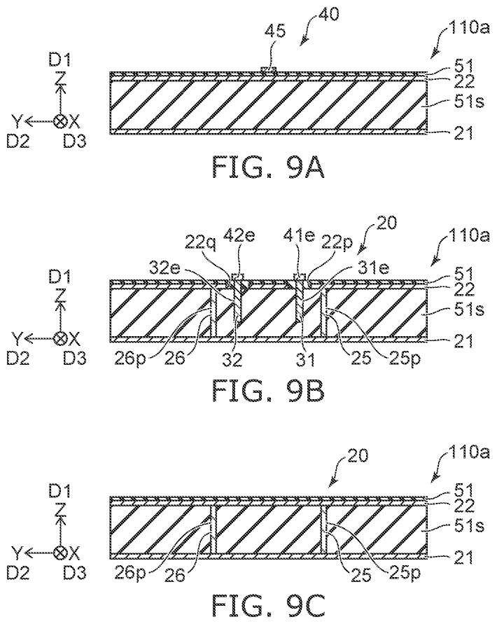

FIGS. 8A to 8E and FIGS. 9A to 9C are schematic cross-sectional views illustrating the transition circuit according to the first embodiment.

FIG. 8A is a cross-sectional view taken along the line A1-A2 in FIG. 7. FIG. 8B is a cross-sectional view taken along the line A3-A4 in FIG. 7. FIG. 8C is a cross-sectional view taken along the line A5-A6 in FIG. 7. FIG. 8D is a cross-sectional view taken along the line A7-A8 in FIG. 7. FIG. 8 is a cross-sectional view taken along the line A9-A10 in FIG. 7. FIG. 9A is a cross-sectional view taken along the line B1-B2 in FIG. 7. FIG. 9B is a cross-sectional view taken along the line B3-B4 in FIG. 7. FIG. 9C is a cross-sectional view taken along the line B5-B6 in FIG.

As shown in FIG. 7, in a transition circuit 110a according to the embodiment, the first side portion 25 includes a plurality of first conductive pillars 25p arranged in the third direction D3. The second side portion 26 includes a plurality of second conductive pillars 26p arranged in the third direction D3. The third direction D3 crosses a plane including the first direction D1 and the second direction D2. The third direction D3 is, for example, the X-axis direction. The configuration of the transition circuit 110a except for this may be the same as the configuration of the transition circuit 110. Radiation loss can also be reduced in the transition circuit 110a. A transition circuit whose characteristics can be improved can be provided.

The waveguide 20 functions, for example, as SIW (substrate integrated waveguide). The plurality of first conductive pillars 25p electrically connect the first conductive layer 21 to the second conductive layer 22. The plurality of second conductive pillars 26p electrically connect the first conductive layer 21 to the second conductive layer 22.

The third side portion 28 includes a plurality of third conductive pillars 28p. The plurality of third conductive pillars 28p are arranged along the second direction D2. The plurality of third conductive pillars 28p electrically connect the first conductive layer 21 to the second conductive layer 22.

The pitch of the plurality of first conductive pillars 25p may be, for example, ¼ or less of the waveguide wavelength λg. The pitch of the plurality of second conductive pillars 26p may be, for example, ¼ or less of the waveguide wavelength λg. The pitch of the plurality of third conductive pillars 28p may be, for example, ¼ or less of the waveguide wavelength λg.

In the transition circuit 110 and the transition circuit 110a, the first conductive portion 31 is separated from the first conductive layer 21, the second conductive layer 22, the first side portion 25, and the second side portion 26. The second conductive portion 32 is separated from the first conductive layer 21, the second conductive layer 22, the first side portion 25, and the second side portion 26.

In the transition circuit 110 and the transition circuit 110a, the second conductive layer 22 includes the first opening 22p and the second opening 22q. The first end portion 41e of the first connecting portion 41 is connected to the first conductive portion 31 via the first opening 22p. The second end portion 42e of the second connecting portion 42 is connected to the second conductive portion 32 via the second opening 22q. The first opening 22p may be circular, for example. The second opening 22q may be circular, for example. For example, the distance between the first conductive portion 31 and the second conductive layer 22 is made uniform. For example, the distance between the second conductive portion 32 and the second conductive layer 22 is made uniform. For example, reflection loss is further suppressed.

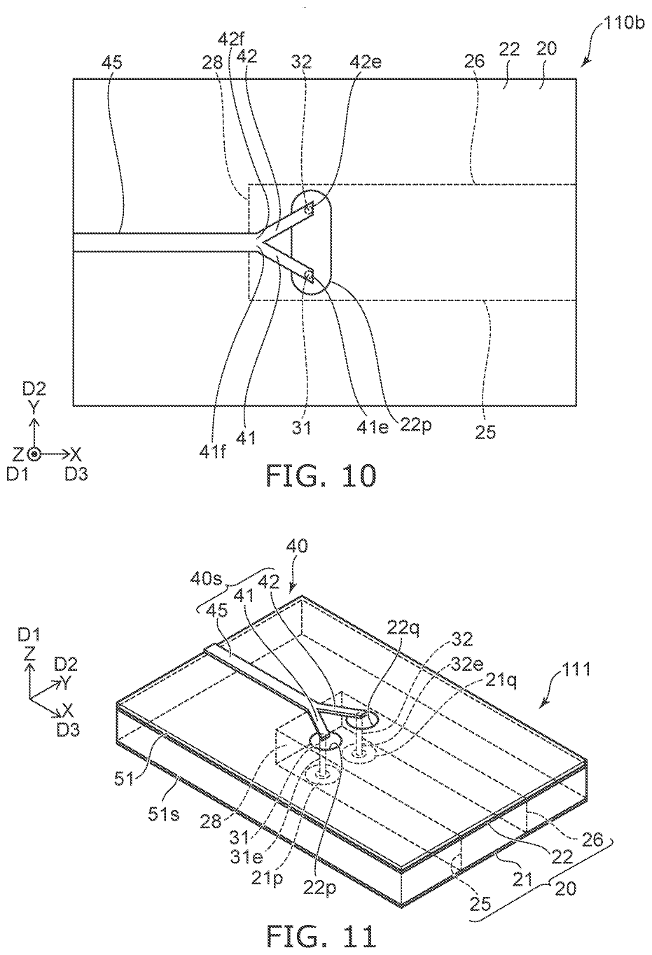

FIG. 10 is a schematic plan view illustrating a transition circuit according to the first embodiment.

As shown in FIG. 10, in a transition circuit 110b according to the embodiment, the second conductive layer 22 includes the first opening 22p. One opening is provided. The configuration of the transition circuit 110b except for this may be the same as the configuration of the transition circuit 110 or the transition circuit 110a.

In the transition circuit 110b, the first end portion 41e is connected to the first conductive portion 31 via the first opening 22p. The second end portion 42e is connected to the second conductive portion 32 via the first opening 22p. Radiation loss can also be reduced in the transition circuit 110b. A transition circuit whose characteristics can be improved can be provided. The configuration of the transition circuit 110a (a plurality of conductive pillars) may be applied to the transition circuit 110b.

FIG. 11 is a schematic perspective view illustrating a transition circuit according to the first embodiment.

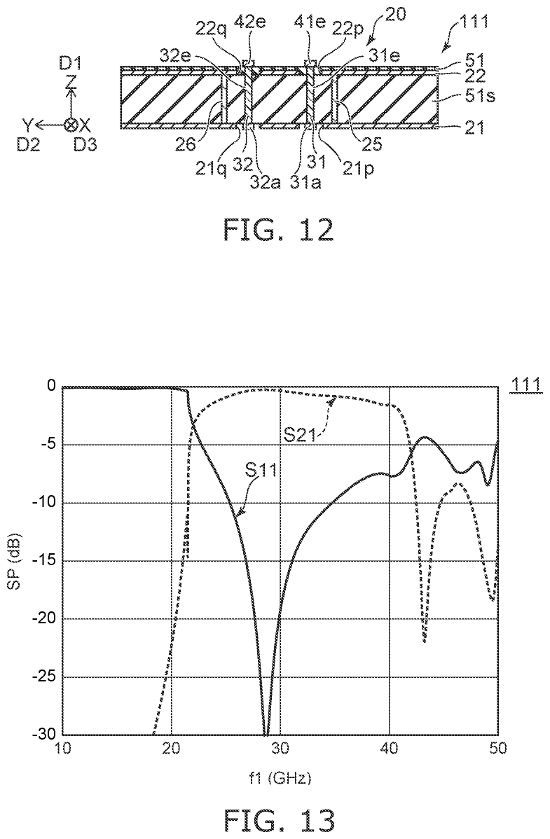

FIG. 12 is a schematic cross-sectional view illustrating the transition circuit according to the first embodiment.

As shown in FIG. 11, in a transition circuit 111 according to the embodiment, the first conductive layer 21 includes an opening 21p and an opening 21q. The configuration of the transition circuit 111 except for this may be the same as the configuration of the transition circuit 110 or the transition circuit 110a.

In the transition circuit 111, the first conductive portion 31 pierces base 51s along the first direction D1. The second conductive portion 32 pierces the base 51s along the first direction D1. Radiation loss can also be reduced in the transition circuit 111. A transition circuit whose characteristics can be improved can be provided. In the transition circuit 111, the configuration (a plurality of conductive pillars) of the transition circuit 110a may be applied.

As shown in FIG. 12, in the transition circuit 111, the first conductive portion 31 further includes a first conductive member 31a connected to the first extending portion 31e. The first extending portion 31e is provided between at least a part of the first end portion 41e and the first conductive member 31a. The second conductive portion 32 further includes a second conductive member 32a connected to the second extending portion 32e. The second extending portion 32e is provided between at least a part of the second end portion 42e and the second conductive member 32a.

For example, a width (length in the X-Y plane) of the first conductive member 31a is greater than a width (length in the X-Y plane) of the first extending portion 31e. For example, a width (length in the X-Y plane) of the second conductive member 32a is larger than a width (length in the X-Y plane) of the second extending portion 32e. “Width” may be, for example, “diameter.”

FIG. 13 is a graph illustrating the characteristics of the transition circuit according to the first embodiment.

FIG. 13 illustrates the characteristics of the transition circuit 111. The horizontal axis in FIG. 13 is the frequency f1. The vertical axis is the frequency characteristic SP of the amplitude of the S-parameter. FIG. 13 exemplifies the amplitude S11 of the reflection coefficient and the amplitude S21 of the transmission coefficient. In this example, the effects of material loss are ignored. As shown in FIG. 13, in the frequency f1 range of 27 GHz to 31 GHZ, the amplitude S11 of the reflection coefficient is less than-15 dB. In the frequency f1 range of 28 GHz to 29 GHz, the amplitude S21 of the transmission coefficient exceeds-0.3 dB. Radiation loss is suppressed. Low reflection transition is possible.

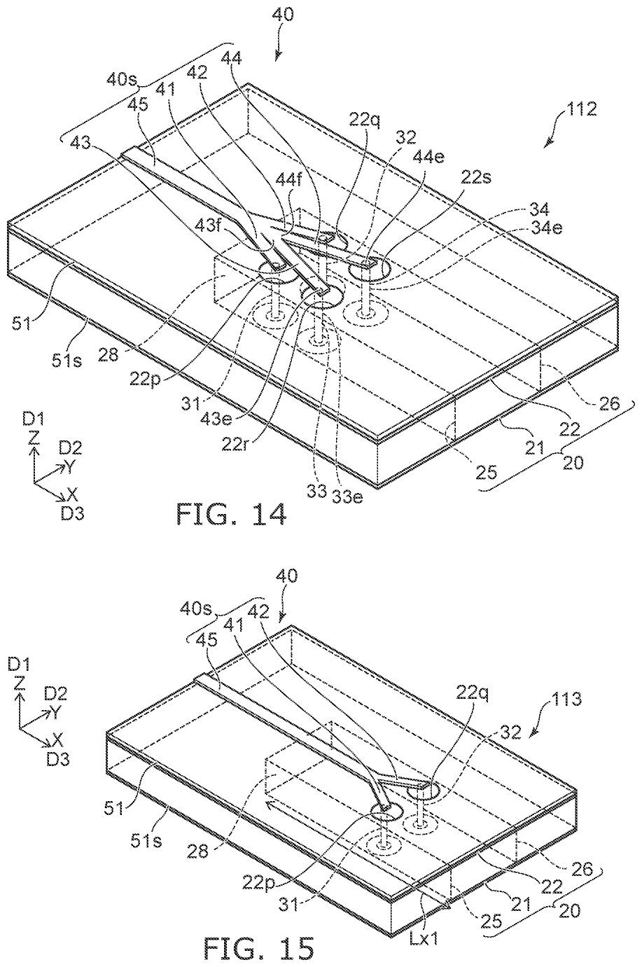

FIG. 14 is a schematic perspective view illustrating a transition circuit according to the first embodiment.

As shown in FIG. 14, a transition circuit 112 according to the embodiment includes a third conductive portion 33. The transition circuit 113 may include a fourth conductive portion 34. The signal line 40s includes a third connecting portion 43. The signal line 40s may include a fourth connecting portion 44. The configuration of the transition circuit 112 except for the above may be the same as the configuration of the transition circuit 110 or the transition circuit 110a.

The third conductive portion 33 is provided between the first side portion 25 and the second side portion 26 in the second direction D2. The third conductive portion 33 includes a third extending portion 33e extending along the first direction D1. The third extending portion 33e is separated from the second conductive layer 22. In this example, the second conductive layer 22 includes a third opening 22r. The third extending portion 33e passes through the third opening 22r. The third connecting portion 43 of the signal line 40s includes a third end portion 43e and a third other end portion 43f. The third other end portion 43f is connected to the first line portion 45. The third end portion 43e is connected to the third conductive portion 33.

The fourth conductive portion 34 is provided between the third conductive portion 33 and the second side portion 26 in the second direction D2. The fourth conductive portion 34 includes a fourth extending portion 34e extending along the first direction D1. The fourth extending portion 34e is separated from the second conductive layer 22. In this example, the second conductive layer 22 includes a fourth opening 22s. The fourth extending portion 34e passes through the fourth opening 22s. The fourth connecting portion 44 of the signal line 40s includes a fourth end portion 44e and a fourth other end portion 44f. The fourth other end portion 44f is connected to the first line portion 45. The fourth end portion 44e is connected to the fourth conductive portion 34.

Radiation loss can also be reduced in the transition circuit 112. A transition circuit whose characteristics can be improved can be provided. In the transition circuit 112, the configuration (a plurality of conductive pillars) of the transition circuit 110a may be applied.

FIG. 15 is a schematic perspective view illustrating a transition circuit according to the first embodiment.

As shown in FIG. 15, in a transition circuit 113 according to the embodiment, a position of the first conductive portion 31 in the X-axis direction is near the center position of the first side portion 25 in the X-axis direction. The above “l” and “k” may be any integer greater than 0.

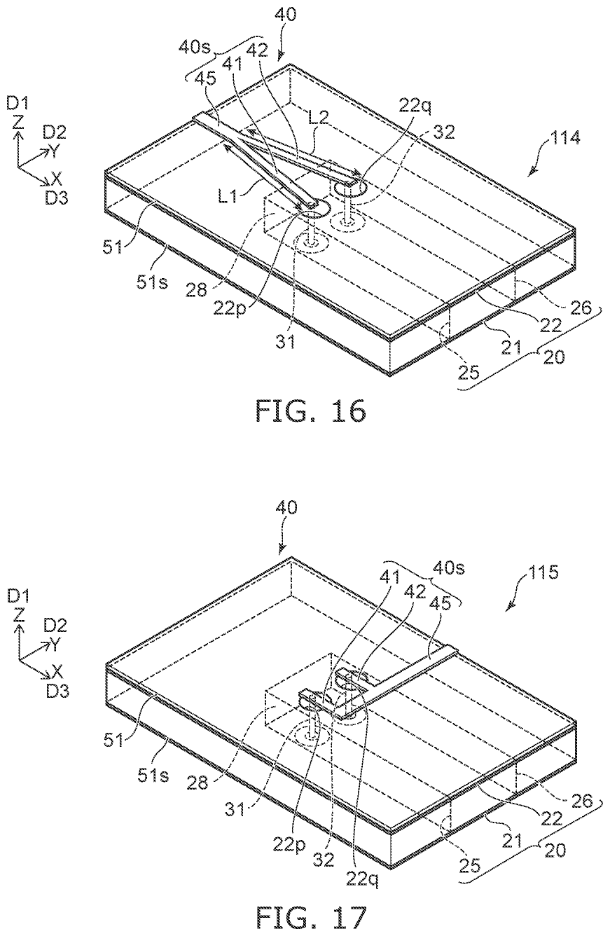

FIG. 16 is a schematic perspective view illustrating a transition circuit according to the first embodiment.

As shown in FIG. 16, in a transition circuit 114 according to the embodiment, the first length L1 is longer than the first length L1 in the transition circuit 110. In the transition circuit 114, the second length L2 is longer than the second length L2 in the transition circuit 110. The configuration of the transition circuit 114 except for this may be the same as the configuration of the transition circuit 110 or the transition circuit 110a. The above “n” and “m” may be any integer greater than or equal to 0. “n” and “m” may be any integer greater than 0.

FIG. 17 is a schematic perspective view illustrating a transition circuit according to the first embodiment.

As shown in FIG. 17, in a transition circuit 115 according to the embodiment, the first line portion 45 extends along the second direction D2. The configuration of the transition circuit 115 except for this may be the same as the configuration of the transition circuit 110 or the transition circuit 110a. In the embodiment, the first line portion 45 may extend in any direction.

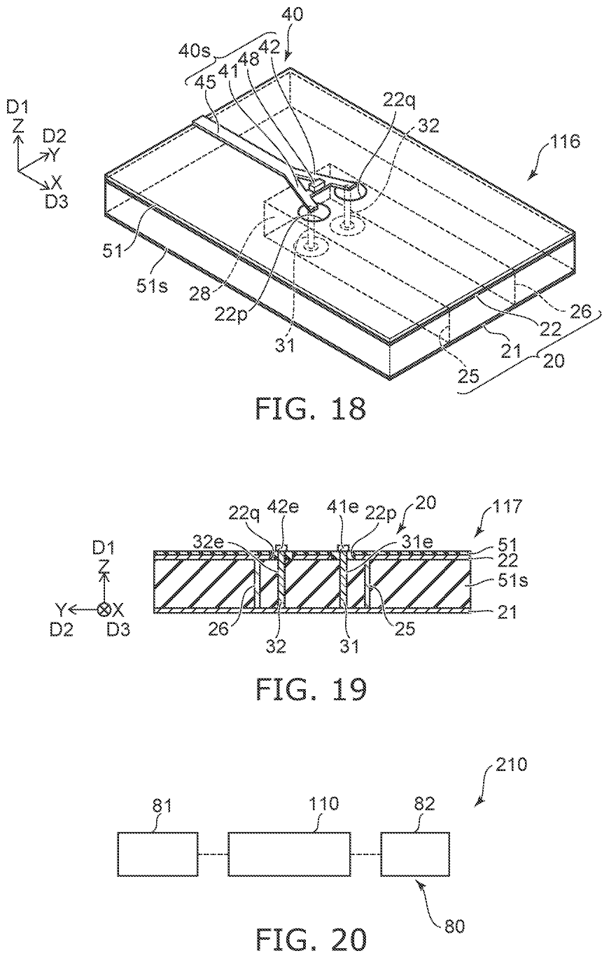

FIG. 18 is a schematic perspective view illustrating a transition circuit according to the first embodiment.

As shown in FIG. 18, in a transition circuit 116 according to the embodiment, the signal line 40s further includes a resistance element 48. The configuration of the transition circuit 116 except for this may be the same as the configuration of the transition circuit 110 or the transition circuit 110a.

In the transition circuit 116, a part of the resistance element 48 is electrically connected to a part of the first connecting portion 41. Another part of the resistance element 48 is electrically connected to a part of the second connecting portion 42. By providing the resistance element 48, impedance can be appropriately set.

Radiation loss can also be reduced in the transition circuits 113 to 116. A transition circuit whose characteristics can be improved can be provided. The configuration of the transition circuit 110a (a plurality of conductive pillars) may be applied to the transition circuits 113 to 116.

FIG. 19 is a schematic cross-sectional view illustrating a transition circuit according to the first embodiment.

As shown in FIG. 19, in a transition circuit 117 according to the embodiment, the first conductive portion 31 and the second conductive portion 32 are in contact with the first conductive layer 21. The configuration of the transition circuit 117 except for this may be the same as the configuration of the transition circuit 110 or the transition circuit 110a. Radiation loss can also be reduced in the transition circuit 117. A transition circuit whose characteristics can be improved can be provided. In the transition circuit 117, the configuration (a plurality of conductive pillars) of the transition circuit 110a may be applied.

In any transition circuit according to the first embodiment and its modification, the first conductive member 31a and the second conductive member 32a described above may be provided.

### Second Embodiment

The second embodiment relates to a communication device.

FIG. 20 is a schematic diagram illustrating the communication device according to the second embodiment.

As shown in FIG. 20, a communication device 210 according to the embodiment includes the transition circuit (for example, the transition circuit 110) according to the first embodiment and an electronic circuit 80. The electronic circuit 80 is configured to be coupled with the transition circuit 110. The electronic circuit 80 may include, for example, an antenna 81 and a processing circuit 82. In the communication device according to the embodiment, low-loss communication is possible.

For example, in high frequency circuits such as communication device, filters are used to remove unnecessary signals. Filters include various resonators, such as SIW resonators and microstrip resonators. For example, SIW resonators are often used in quasi-millimeter wave or millimeter wave bands. In the SIW resonator, it is easy to obtain high integration, high Q factor, and low cost. For example, in a SIW resonator, a high Q factor can be easily obtained by increasing the thickness of the substrate. In SIW, it is not easy to connect to other circuits (for example, planar circuits). The planar circuits include, for example, microstrip lines or coplanar waveguides. As the connecting portion, for example, a tapered line is used as a transition circuit. It is difficult to reduce loss in tapered lines. For example, one transition circuit causes an insertion loss of about 0.5 dB.

In the embodiments, special structures are applied to the transition circuit. According to embodiments, low radiation loss is obtained. For example, low insertion loss can be obtained. A transition circuit whose characteristics can be improved can be provided.

The embodiments may include the following configurations (e.g., technical proposals):

### (Configuration 1)

A transition circuit, comprising:
a waveguide including
   a first conductive layer,
   a second conductive layer, a direction from the first conductive layer to the second conductive layer being along a first direction,
   a first side portion electrically connecting the first conductive layer to the second conductive layer, and
   a second side portion electrically connecting the first conductive layer to the second conductive layer, a second direction from the first side portion to the second side portion crossing the first direction;
a first conductive portion provided between the first side portion and the second side portion in the second direction, the first conductive portion including a first extending portion extending along the first direction, the first extending portion being separated from the second conductive layer;
a second conductive portion provided between the first conductive portion and the second side portion in the second direction, the second conductive portion including a second extending portion extending along the first direction, the second extending portion being separated from the second conductive layer; and
a transmission line including a signal line, the signal line including a first line portion, a first connecting portion, and a second connecting portion, the first connecting portion including a first end portion and a first other end portion, the second connecting portion including a second end portion and a second other end portion, the first other end portion and the second other end portion being connected to the first line portion, the first end portion being connected to the first conductive portion, the second end portion being connected to the second conductive portion, a part of the second conductive layer being provided between the first conductive layer and at least a part of the signal line.

### (Configuration 2)

The transition circuit according to Configuration 1, wherein
the second conductive layer includes a first opening and a second opening,
the first end portion is connected to the first conductive portion via the first opening, and
the second end portion is connected to the second conductive portion through the second opening.

### (Configuration 3)

The transition circuit according to Configuration 1, wherein
the second conductive layer includes a first opening,
the first end portion is connected to the first conductive portion via the first opening, and
the second end portion is connected to the second conductive portion through the first opening.

### (Configuration 4)

The transition circuit according to any one of Configurations 1-3, further comprising:
a base being insulating; and
a first insulating layer,
at least a part of the base being provided between the first conductive layer and the second conductive layer, and
at least a part of the first insulating layer being provided between the part of the second conductive layer and the at least a part of the signal line.

### (Configuration 5)

The transition circuit according to any one of Configurations 1-4, wherein
a first length between the first other end portion and the first end portion is not less than 0.8 times and not more than 1.2 times a value of (1+2n)/4 times a waveguide wavelength of the waveguide,
a second length between the second other end portion and the second end portion is not less than 0.8 times and not more than 1.2 times a value of (1+2m)/4 times the waveguide wavelength,
the n is an integer not less than 0 and not more than 10, and
the m is an integer not less than 0 and not more than 10.

### (Configuration 6)

The transition circuit according to any one of Configurations 1-4, wherein
the waveguide further includes a third side portion electrically connecting the first conductive layer with the second conductive layer,
the third side portion overlaps the transmission line in the first direction,
a first conductive portion distance between the third side portion and the first conductive portion along a third direction is not less than 0.8 times and not more than 1.2 times a value of (1+2l)/4 times a waveguide wavelength of the waveguide,
a second conductive portion distance between the third side portion and the second conductive portion along the third direction is not less than 0.8 times and not more than 1.2 times of a value of (1+2k)/4 times the waveguide wavelength,
the third direction crosses a plane including the first direction and the second direction,
the l is an integer not less than 0 and not more than 10, and
the k is an integer not less than 0 and not more than 10.

### (Configuration 7)

The transition circuit according to any one of Configurations 1-5, wherein
the first side portion includes a plurality of first conductive pillars arranged in a third direction,
the second side portion includes a plurality of second conductive pillars arranged in the third direction, and
the third direction crosses a plane including the first direction and the second direction.

### (Configuration 8)

The transition circuit according to any one of Configurations 1-7, wherein
the transmission line further includes an opposing conductive layer,
a direction from the opposing conductive layer to the signal line is along the first direction, and
a first distance between the first conductive layer and the second conductive layer along the first direction is longer than a second distance between the opposing conductive layer and the signal line along the first direction.

### (Configuration 9)

The transition circuit according to any one of Configurations 1-6, wherein
the first line portion extends along a signal line extending direction,
the first connecting portion extends along a first extending direction, a first connecting portion width of the first connecting portion along a first crossing direction being narrower than a signal line width of the signal line along a signal line crossing direction crossing the signal line extending direction, and
the first crossing direction is perpendicular to the first extending direction and the first direction.

### (Configuration 10)

The transition circuit according to any one of Configurations 1-8, wherein
a first connecting portion extends along a first extending direction,
a second connecting portion extends along the second extending direction,
the first line portion extends along a signal line extending direction, and
the signal line extending direction is inclined with respect to the first extending direction and is inclined with respect to the second extending direction.

### (Configuration 11)

The transition circuit according to any one of Configurations 1-10, wherein
the first connecting portion is plane symmetrical with respect to the second connecting portion with respect to a first plane,
the first plane is along the first direction and perpendicular to the second direction, and
the first plane passes through a midpoint in the second direction between the first side portion and the second side portion.

### (Configuration 12)

The transition circuit according to any one of Configurations 1-11, wherein
the first conductive portion is separated from the first conductive layer, the second conductive layer, the first side portion and the second side portion, and
the second conductive portion is separated from the first conductive layer, the second conductive layer, the first side portion, and the second side portion.

### (Configuration 13)

The transition circuit according to any one of Configurations 1-12, wherein
the first conductive portion further includes a first conductive member connected to the first extending portion,
the first extending portion is provided between at least a part of the first end portion and the first conductive member,
the second conductive portion further includes a second conductive member connected to the second extending portion, and
the second extending portion is provided between at least a part of the second end portion and the second conductive member.

### (Configuration 14)

The transition circuit according to any one of Configurations 1-13, wherein
the transmission line includes at least one of a microstrip line, a strip line, or a coplanar waveguide.

### (Configuration 15)

The transition circuit according to Configuration 2, wherein
the first opening is circular, and
the second opening is circular.

### (Configuration 16)

The transition circuit according to Configuration 8, wherein
the opposing conductive layer is continuous with the second conductive layer.

### (Configuration 17)

The transition circuit according to any one of Configurations 1-16, further comprising:
a third conductive portion,
the third conductive portion being provided between the first side portion and the second side portion in the second direction, the third conductive portion including a third extending portion extending along the first direction, the third extending portion being separated from the second conductive layer,
the signal line further including a third connecting portion,
the third connecting portion including a third end portion and a third other end portion,
the third other end portion being connected to the first line portion, and
the third end portion being connected to the third conductive portion.

### (Configuration 18)

The transition circuit according to any one of Configurations 1-11, wherein
the first conductive portion is in contact with the first conductive layer, and
the second conductive portion is in contact with the first conductive layer.

### (Configuration 19)

The transition circuit according to any one of Configurations 1-18, wherein
the signal line further includes a resistance element,
a part of the resistance element is electrically connected to a part of the first connecting portion, and
another part of the resistance element is electrically connected to a part of the second connecting portion.

### (Configuration 20)

A communication device, comprising:
the transition circuit according to any one of Configurations 1 to 19; and
an electronic circuit configured to be coupled with the transition circuit.

According to the embodiment, it is possible to provide a transition circuit and a communication device whose characteristics can be improved.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in the transition circuits such as waveguides, transmission lines, conductive layers, conductive portions, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all transition circuits and all communication devices practicable by an appropriate design modification by one skilled in the art based on the transition circuits and communication devices described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A transition circuit, comprising:
a waveguide including
a first conductive layer,
a second conductive layer, a direction from the first conductive layer to the second conductive layer being along a first direction,
a first side portion electrically connecting the first conductive layer to the second conductive layer, and
a second side portion electrically connecting the first conductive layer to the second conductive layer, a second direction from the first side portion to the second side portion crossing the first direction;
a first conductive portion provided between the first side portion and the second side portion in the second direction, the first conductive portion including a first extending portion extending along the first direction, the first extending portion being separated from the second conductive layer;
a second conductive portion provided between the first conductive portion and the second side portion in the second direction, the second conductive portion including a second extending portion extending along the first direction, the second extending portion being separated from the second conductive layer; and
a transmission line including a signal line, the signal line including a first line portion, a first connecting portion, and a second connecting portion, the first connecting portion including a first end portion and a first other end portion, the second connecting portion including a second end portion and a second other end portion, the first other end portion and the second other end portion being connected to the first line portion, the first end portion being connected to the first conductive portion, the second end portion being connected to the second conductive portion, a part of the second conductive layer being provided between the first conductive layer and at least a part of the signal line.

2. The transition circuit according to claim 1, wherein
the second conductive layer includes a first opening and a second opening,
the first end portion is connected to the first conductive portion via the first opening, and
the second end portion is connected to the second conductive portion through the second opening.

3. The transition circuit according to claim 1, wherein
the second conductive layer includes a first opening,
the first end portion is connected to the first conductive portion via the first opening, and
the second end portion is connected to the second conductive portion through the first opening.

4. The transition circuit according to claim 1, further comprising:
a base being insulating; and
a first insulating layer,
at least a part of the base being provided between the first conductive layer and the second conductive layer, and
at least a part of the first insulating layer being provided between the part of the second conductive layer and the at least a part of the signal line.

5. The transition circuit according to claim 1, wherein
a first length between the first other end portion and the first end portion is not less than 0.8 times and not more than 1.2 times a value of (1+2n)/4 times a waveguide wavelength of the waveguide,
a second length between the second other end portion and the second end portion is not less than 0.8 times and not more than 1.2 times a value of (1+2m)/4 times the waveguide waveguide,
the n is an integer not less than 0 and not more than 10, and
the m is an integer not less than 0 and not more than 10.

6. The transition circuit according to claim 1, wherein
the waveguide further includes a third side portion electrically connecting the first conductive layer with the second conductive layer,
the third side portion overlaps the transmission line in the first direction,
a first conductive portion distance between the third side portion and the first conductive portion along a third direction is not less than 0.8 times and not more than 1.2 times a value of (1+2l)/4 times a waveguide wavelength of the waveguide,
a second conductive portion distance between the third side portion and the second conductive portion along the third direction is not less than 0.8 times and not more than 1.2 times of a value of (1+2k)/4 times the waveguide wavelength,
the third direction crosses a plane including the first direction and the second direction,
the l is an integer not less than 0 and not more than 10, and
the k is an integer not less than 0 and not more than 10.

7. The transition circuit according to claim 1, wherein
the first side portion includes a plurality of first conductive pillars arranged in a third direction,
the second side portion includes a plurality of second conductive pillars arranged in the third direction, and
the third direction crosses a plane including the first direction and the second direction.

8. The transition circuit according to claim 1, wherein
the transmission line further includes an opposing conductive layer,
a direction from the opposing conductive layer to the signal line is along the first direction, and
a first distance between the first conductive layer and the second conductive layer along the first direction is longer than a second distance between the opposing conductive layer and the signal line along the first direction.

9. The transition circuit according to claim 1, wherein
the first line portion extends along a signal line extending direction,
the first connecting portion extends along a first extending direction, a first connecting portion width of the first connecting portion along a first crossing direction being narrower than a signal line width of the signal line along a signal line crossing direction crossing the signal line extending direction, and
the first crossing direction is perpendicular to the first extending direction and the first direction.

10. The transition circuit according to claim 1, wherein
a first connecting portion extends along a first extending direction,
a second connecting portion extends along the second extending direction,
the first line portion extends along a signal line extending direction, and
the signal line extending direction is inclined with respect to the first extending direction and is inclined with respect to the second extending direction.

11. The transition circuit according to claim 1, wherein
the first connecting portion is plane symmetrical with respect to the second connecting portion with respect to a first plane,
the first plane is along the first direction and perpendicular to the second direction, and
the first plane passes through a midpoint in the second direction between the first side portion and the second side portion.

12. The transition circuit according to claim 1, wherein
the first conductive portion is separated from the first conductive layer, the second conductive layer, the first side portion and the second side portion, and
the second conductive portion is separated from the first conductive layer, the second conductive layer, the first side portion, and the second side portion.

13. The transition circuit according to claim 1, wherein
the first conductive portion further includes a first conductive member connected to the first extending portion,
the first extending portion is provided between at least a part of the first end portion and the first conductive member,
the second conductive portion further includes a second conductive member connected to the second extending portion, and
the second extending portion is provided between at least a part of the second end portion and the second conductive member.

14. The transition circuit according to claim 1, wherein
the transmission line includes at least one of a microstrip line, a strip line, or a coplanar waveguide.

15. The transition circuit according to claim 2, wherein
the first opening is circular, and
the second opening is circular.

16. The transition circuit according to claim 8, wherein
the opposing conductive layer is continuous with the second conductive layer.

17. The transition circuit according to claim 1, further comprising:
a third conductive portion,
the third conductive portion being provided between the first side portion and the second side portion in the second direction, the third conductive portion including a third extending portion extending along the first direction, the third extending portion being separated from the second conductive layer,
the signal line further including a third connecting portion,
the third connecting portion including a third end portion and a third other end portion,
the third other end portion being connected to the first line portion, and
the third end portion being connected to the third conductive portion.

18. The transition circuit according to claim 1, wherein
the first conductive portion is in contact with the first conductive layer, and
the second conductive portion is in contact with the first conductive layer.

19. The transition circuit according to claim 1, wherein
the signal line further includes a resistance element,
a part of the resistance element is electrically connected to a part of the first connecting portion, and
another part of the resistance element is electrically connected to a part of the second connecting portion.

20. A communication device, comprising:
the transition circuit according to claim 1; and
an electronic circuit configured to be coupled with the transition circuit.
